(19) United States
(12) Patent Application Publication
(10) Pub. No.: US 2007/0224327 A1
(43) Pub. Date: Sep. 27, 2007

(54) Food product comprising fresh fruit

(75) Inventors: Dietmar Otte, Aachen (DE); Karl-Heinz Johnen, Aachen (DE); Marc Mueller, Uebach-Palenberg (DE)

Correspondence Address: Ursula B. Day;Ursula B. Day, Esq., Suite 4714, 350 Fifth Avenue, New York, NY, 10118, US

(73) Assignee: Zentis GmbH & Co. KG, Aachen (DE)

(21) Appl. No.: 11/690,369

(22) Filed: Mar. 23, 2007

(30) Foreign Application Priority Data
Mar. 23, 2006 (DE) 10 2006 013 814.7

(51) Int. Cl. A23L 1/05

(52) U.S. Cl. 426/577; 426/615

(57) ABSTRACT

Described is a food product comprising: (a) fresh, whole fruit and/or fresh fruit pieces and (b) an aqueous preparation, which fills partially or completely interstices between the fresh, whole fruit and/or the fresh fruit pieces comprising: (i) in a total weight of more than 25 weight present relative to the total weight of the aqueous preparation, dissolved solids selected from the group consisting of: sugars, sugar alcohols, sweeteners, fructo oligosaccharide, poly dextrose, inert fibers and their mixtures, (ii) one or more galactomannane for thickening of the preparation under storage conditions by binding water from the fruit and/or fruit pieces.

The present invention to a food product comprising fresh whole fruit and/or fresh pieces of fruit. The invention also comprises the use of an aqueous, flowable preparation used as a binder agent for binding of fresh, whole fruit and/or fresh pieces of fruit, as well as respective methods for preparing the food product according to the invention. Finally, the invention refers also a ready-to-eat food product, which is preserved by storing of a food product according to the invention.

In the context of the presently described invention, fresh whole fruit respectively fruit pieces are fruits and fruit pieces which are not conserved by thermal processes (such as pasteurizing, boiling or preserving by sterilization) and which are not preserved by high pressure methods or not preserved by drying, candying or sulphurizing the fruit. Thus, the term fresh whole fruit and fruit pieces are defined as including freshly harvested fruits as well as frozen fruits (TK Fruit) and fruits stored in other ways and which have not been treated in accordance with the afore-stated treatments.

In the paragraphs following the term fresh, whole fruit and/or fresh fruit pieces is sometimes referred to simply as “fresh fruit”.

The consumption of fresh fruit by persons in the context of private households is widely known and refers mostly to eating a single piece of fruit or eating fruit in the form of an in home prepared fruit salad. Preparing in home fruit salad has the disadvantage that the fruit salad can hardly be stored for any amount of time without losing its appetizing looks, since many fruits are getting quickly discolored by exposure to air and thereby turning brown. Furthermore, many fruits partially release their juices, especially when sugar has been added to the fruit salad, whereby the fruit loses all if its original consistency and juiciness. If the prepared fruit salad is not eaten soon after preparation, microbial spoilage becomes an issue. Germ growth renders such food inedible after a period of time and if stored after a certain period of time, depending also on the storage temperature, such foods can become inedible and can even make you sick.

When foods such as fruit salad or packaged fruit, respectively pieces of fruit are industrially prepared and packaged, such as for example in the preparation of semi-liquid “red fruit compote”, the problem of spoilage through germs is mostly prevented when boiling or pasteurization the fruit, respectively the fruit pieces, with subsequent storage of the so treated fruit as preserved fruit.

In private household use, it is also widely customary to combine fresh fruit with milk products. A “milk product” is a food, of which a substantial amount is milk. Milk products, on the one hand are milk types that have been treated in a variety of ways, and on the other hand, products of milk that have been treated through fermentation of milk constituents. Milk products include for example quark, yoghurt, fresh cheese, farmer's cheese and milk based sweet desserts. Such milk product should either be fresh or should have been heat treated to preserve it from easy spoilage and can be prepared as a sweetened or unsweetened type product. In particular, in any private household, use the combination of fresh fruit and milk products oftentimes leads to the effect that the milk product (for example quark or yoghurt) has a watery appearance which is due to the fruit juice that develops mixing with the milk product and the lack of the milk product's capacity to bind water.

This combination of fruit and milk products is also very much a part of the food industry. For example in the retail grocery situation, there are products which are made from a cooked (and in this manner preserved) fruit preparation and which contain thickened fruit juice constituents which are then combined with a further layer of a milk product. In Great Britain for example, products are distributed that combine fruit layered with biscuits and then another layer of pudding, the so-called “trifles”. The biscuit is used to separate the fruit from the pudding and thus prevents liquefaction of the pudding through the fruit juice released by the fruit. In addition, the biscuits are softened by the fruit juice released from the fruit, whereby the product obtains its appetizing appearance.

Such food products which combine fresh fruit with a milk product are rarely produced on an industrial scale. There is, for example, a milk product originating from a Swiss milking company known as “Aargauer”, which is a combination of yoghurt and fresh fruit. In the lower portion of the yoghurt cup is the fruit sprinkled with sugar. The remainder of the cup is filled with yoghurt which also fills the spaces between the fruit pieces in the bottom of the cup. This known product has however the following drawbacks.
a) There is no separation layer between the fruit and the milk product (yoghurt) which could prevent liquefaction of the milk product due to the fruit juices flowing from the fruit.
b) The fruit which is surrounded by yoghurt can float within the yoghurt layer in the direction of the surface because the fruit containing a relatively high portion of air (up to 20 Vol. %) have a lower specific weight than that of the milk product, whose viscosity is already reduced through the fruit juice emerging from the fruit initially.
c) The yoghurt is additionally discolored from the fruit by release of unwanted liquid, which, especially when it concerns red fruit such as cherries, raspberries and black berries containing water soluble dye stuff is undesirable and constitutes a definite drawback.
d) After only a brief storage time, an unattractive fluid of mostly fruit juice collects at the bottom of the yoghurt cup. Thus, after only a brief storage time, the entire appearance of the food product, the fruit at the bottom of the cup has become very unattractive and therefore the entire product appears unattractive
   Object

According to a primary aspect of the present invention, a food product which comprises fresh fruit remains fresh looking over a longer period of time, whereby the original consistency of the food product and its appearance is essentially preserved in particular at storage temperatures in the range from 3° C. to 10° C., preferably from 6° C. to 8° C.

The food product according to the invention comprising fresh fruit must also apply to fresh fruit in combination with milk products, especially yoghurt or quark and has to retain an appetizing and a highly attractive appearance in connection with milk products over a longer period of time.

Solution

The object of the invention is solved by the present invention of a food product comprising the components
a) whole fresh food and/or fresh fruit pieces
b) an aqueous, free flowing preparation, which completely or partially fills the interstices between fresh whole fruit and/or fruit pieces comprising:
   (i) A total amount of more than 25% by weight, preferably greater than 40% by weight relative to the total weight of the aqueous preparation of dissolved solids selected from the group consisting of sugars, sugar alcohols, sweeteners, fructo oligosaccharide, dextrose and other water soluble ballast stuffs and mixtures of the foregoing
   (ii) one or more galactomannane for thickening the preparation under storage conditions by means of binding the water from the fruits and/or fruit pieces.

With respect to the definition of the term “fresh whole fruit and/or fresh fruit pieces” reference is made to the foregoing comments.

The term “sugars” comprises also especially such products that are in accordance with the German sugar directive of Oct. 23, 2003 and the products as listed in the appendix thereto. The term “sugars” comprises also especially saccharose, also in the form of semi-white sugar, white sugar, refined sugar, refined white sugar. Furthermore the term “sugar” also includes products which are designated as liquid sugar, invert liquid sugar, invert sugar syrup, glucose syrup, dried glucose syrup, dextrose (containing crystal water or not containing crystal water) or fructose. The use of saccharose is preferred in the present invention.

The term “sugar alcohols” includes but is not limited to polyhydroxy compounds which result from the reduction of the carbonyl groups of mono saccharides. In particular, the term “sugar alcohols” comprises the substances such as sorbite (sorbite syrup), mannite, isomalt, maltite, maltite syrup, lactite and xylite. (compare in this connection appendix 2 to the German supplement admission directive of 1998).

The term “sweeteners” comprises compounds of synthetic and natural origin, which have no gross caloric value or which have a negligible physiological gross caloric value relative to their sweetening effect, and which exhibit a sweetening capacity which is by multiples higher than that of saccharose. The term “sweetener” comprises especially those that are certified in the European Union such as saccharine, cyclamate, aspertame, acesulfame, taumatine, sucralose and NHDC.

The term “fructo oligosaccharide” includes beta-d-fructane having 2 to 10 fructose units, wherein the fructose units are coupled by beta-2,1-glycosidic bonds, wherein a single d-glucose unit is located at the terminal chain end. Fructo oligosaccharides are considered prebiotic roughage.

The term “polydextrose” defines a polymer, which is produced through polycondensation of glucose with sorbite and citric acid. Polydextrose does not taste sweet, however it improves the texture and the taste impression of food stuffs and acts as a bulking agent. In combination with sweeteners, it can be used as a replacement for saccharose.

The term “other inert material or roughage” is defined as food stuffs that are water insoluble and not digestible by humans and are or may be present in the food product but not explicitly named as a component (i) as recited above, that is they are not sugars, sugar alcohols, fructo oligosaccharides or polydextroses and are likewise not a component among the components named under (ii) or respectively (iii).

The term “galactomannane” defines a group of mostly water soluble polysaccharides, which occur as reserve stuff in the endosperm of seeds for example of leguminoses or cassia grande. The term “galactomannane” especially also includes guar seed powder and carob bean gum as well as tara gum.

The term “guar seed powder” (guar, guar gum, INCI designation: Guar gum, E4120) defines a hydrokolloid, a thickening agent which swells in water. Carob bean gum powder is similar to guar seed powder and also a well known thickening agent.

The component (b) as identified above to be used in the aqueous preparation according to the present invention can comprise other components beside the named components (i) and (ii). Especially preferred further components are also named in the paragraphs below. However it should be noted that the aqueous portion of the aqueous preparation which represents component (b) can be in the form of fruit juice, fruit extract, fruit juice concentrate, fruit puree, mashed fruit or other water based fruit products.

The dissolved compounds in the component (ii) of the aqueous preparation (b) are preferably selected from the group consisting of sugars, sugar alcohols and mixtures thereof.

The present invention is based in particular on the surprising finding that water based preparation comprising the afore-described components (i) and (ii) can bind the fruit juices which emerge from the fresh fruit in a food product of the present invention, without losing any of its consistency and viscosity. Of particular significance here is the use of the component of one or more of the galactomanannes (component (ii)), which must be present in an amount that leads to the thickening of the preparation during storage by means of binding of water from the fruit and/or fruit pieces. In the freshly prepared food product according to the present invention, the aqueous preparation is thus less thickened as compared with a certain time thereafter when liquid from the fruit and/or fruit pieces has transferred into the aqueous preparation. Advantageously, guar seed powder is used in component (ii) of the aqueous preparation (b); wherein other galactomannanes such as carob bean powder can also be utilized.

A food product according to the present invention preferably comprises a component (ii) of the aqueous preparation (b) one or more galactomanannes in the aqueous preparation, in an amount in the range of 0.2% to 0.8% by weight relative to the total amount of the aqueous preparation (b), preferably guar seed powder in an amount in the range of 0.2% to 0.8% by weight.

Due to the presence of galactomannane in the water based preparation which results in a thickening of the preparation by binding the water portion of the fruit or fruit pieces that are present, a formation of liquid at the bottom of the container, (for example a commercially used plastic cup), and the concomitant loss of proper consistency, is thus counteracted. Especially when utilizing for the food product frozen fruit, which due to their frozen consistency is not easily susceptible to mechanical impact (such as pressure), but when defrosted generate an enormous amount of fluid due to the destruction of the fruit's cell structure, the afore-described property of the aqueous preparation which is based on the presence of galctomannane (in particular guar powder) is particularly advantageous. Thereby, accumulation of juices in the area around the fruit and/or fruit pieces in the food product is substantially prevented. The fresh fruit in the product retain their original shape and appear to the consumer fresh and appetizing. Use of the whole fruits in the food product according to the present invention is preferred since they convey to the consumer that the product is of high quality and has high healthful value. Should the food product comprise fruit that are relatively large such as peaches, then the fruit should rather be cut in pieces since the commercial packaging (for example a yoghurt cup) does not hold such a large fruit. However, when cutting the fruit into pieces it is required, the pieces should be kept relatively large, in order to provide for the consumer the association with the original whole fruit. Preferably, fresh fruit having a volume of at least 0.5 cm³ and more preferably a volume of about 1 cm³.

As afore-stated, the component (b) of the food product according to the present invention is the aqueous preparation which preferably contains guar seed powder. Guar seed powder is characterized by its capacity to absorb a great amount of water, when there is a great amount of water present. For example 1 gram of guar seed powder can bind up to about 20 grams of water, so that the aqueous preparation according to the present invention is rendered more viscous but remains homogenous in its consistency when the fresh fruit embedded in the aqueous preparation releases its juices during storage. The property of the guar seed powder is especially positive for the consumption of the food product of the present invention, due to retaining a homogenous consistency and preventing local accumulation of fluids in the food product.

The aqueous preparation (b) containing one or more galactomannanes (e.g. guar seed powder), also contains a number of other dissolved solids in an amount of more than 25% by weight. These are preferable selected from sugars, sugar alcohols, and their mixtures. Thus, in the aqueous preparation according to the invention, the dissolved solids, in particular the sugars and the sugar alcohols and their mixtures, and one or more of the galactomannanes, (e.g. guar seed powder) are competing with each other relative to the binding of water. Therefore, the aqueous preparation is adjusted in such a manner that that at the start condition, that is, before the release of liquid from the fresh fruit into the aqueous preparation, the galactomannane (e.g. guar seed powder) does not exhibit or exhibits only a much reduced water binding capacity. Only after the fruit released liquid into the aqueous preparation, the water content of the aqueous preparation (and thus aqueous activity) increases to such a point, that the galactomannane (e.g. the guar seed powder) reaches a high aqueous activity. At the same time, sugar is released from the component (i) of the aqueous preparation (b) into the fresh fruit, which represents component (a) of the food product according to the invention. Initially, the guar gum exhibits only a low level of water binding activity due to, for example the high sugar content in the aqueous preparation (b) and consequently is not yet present in a bulked condition or is present in a bulked condition to only a small degree. By liquid being released from the fresh fruit into the aqueous preparation and the release of sugar from the aqueous preparation into the fresh fruit, the water activity is increasing and thus the water binding capacity of the guar gum, which binds the liquid from the fruit itself, simultaneously thickens the aqueous preparation.

A preferred food product according to the present invention comprises in the aqueous preparation (b) in addition to the components (i) and (ii), the component (iii) a low esterified amidified pectin. The term “low esterified pectin” designates pectins whose acidic groups are maximally esterified 50% with methanol. Amidified, low esterified pectins require calcium ions for gel formation and the resulting calcium-pectinate gels are heat reversible. At a calcium excess, the amidified pectins have no tendency to coagulate. Especially advantageous is the use of low esterified, preferably amidified pectins in an amount of 0.5% to 1.0% by weight, preferably 0.5% to 0.75% by weight relative to the total amount of the aqueous preparation (b). In this case, the amidified pectin is used in the afore-stated amount preferably in addition to the guar seed powder, which preferably is present at the amount of 0.2% to 0.8% by weight. The properties of guar gum and pectin advantageously complement each other in the corresponding preferred aqueous preparation utilized a component (b) in the food product according to the present invention, such that the food product still has an appetizing and attractive appearance even after an extended shelf time.

Advantageously, the aqueous preparation (b) of the food product of the present invention comprises in addition to components (i) and (ii) and respectively also (iii) one or more acid regulators, whereby the aqueous preparation has a pH value in the range of 4 to 5.

“Acid regulators” are components that change and/or control the pH value of a food product. Preferred in the food products of the present invention are the edible acids respectively their salts, in particular citric acid, and the respective citrates. Lactates, tartrates, phosphates, malates, adipates, gluconates and their respective edible acids can also be utilized.

the food product according to the present invention, the fresh, whole fruits are initially present in frozen condition. The use of frozen fresh fruits is especially advantageous for the industrial preparation of the food products according to the present invention.

In the food product according to the present invention, the aqueous preparation (b) comprises preferably in addition to the components (i), (ii) and (iii) and or (iv) a preservative (v). These preservatives are preferably selected from the group consisting of benzoic acid, sorbic acid and their salts and mixtures thereof.

As an additional thickener, the food product according to the invention can comprise xanthan. The aqueous preparation can also be preserved by pasteurization.

Usually, the food product according to the present invention comprises in addition to the main components (a) and (b) a milk product (c) and/or a soy product, wherein the food product is multilayered and the components (a) and (b) together form the first layer and the component (c) forms a second layer, and whereby the first and second layer preferably adjoin each other but in some cases overlap.

With respect to the term “milk product” reference is made to the foregoing definition. The term “soy product” designates products that result form the treatment of soy beans. In particular, the term comprises, within the scope of this description, products which are commercially available as alternatives to the common commercial milk products, such as for example soy yoghurt or soy quark.

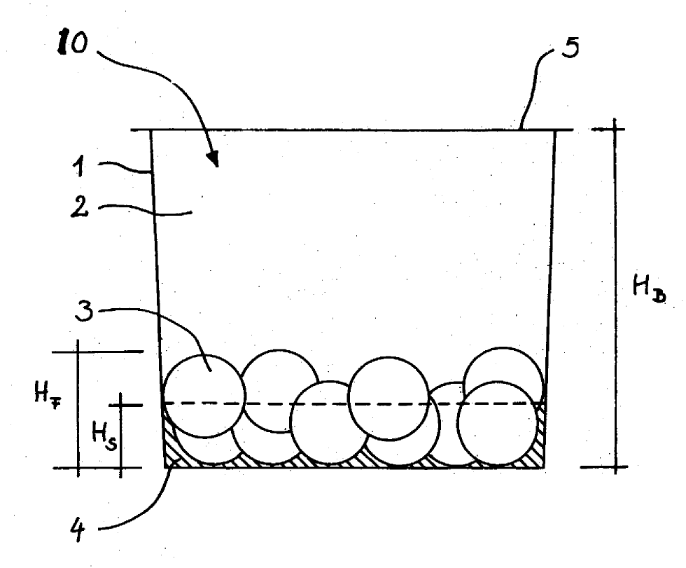

The first and second layer of the preferred food product of the present invention overlap at the point where the first layer is arranged under the second layer and the filling height HF of component (a) in the first layer is higher than the filling height H_{S} of component (b) in the first layer. Compare also the described example below and the FIG. 1. In a particular embodiment of the food product according to the present invention comprising a first and second layer, the filling height H_{S} of component (b) can increase due to storage time by means of binding the fluid from the fruit and/or fruit pieces according to component (a) and the filling height of component (a) can decrease due to the fluid transfer to the component (b). The filling heights H_{S} and H_{F} are thus approaching equal heights during storage.

In the afore-described embodiment of the food product according to the present invention which comprises a first and a second layer the afore-describe advantages are especially advantageous. In particular, the presence of component (b), the aqueous preparation prevents rising of the fruit in the direction of the surface of the food product into the second layer (component c) and perhaps through the second layer. Thus, component (b) acts as a binding agent for component (a), whereby the binding activity of component (b) increases with prolonged storage at least temporarily, since the thickening effect of galactomannane as the component (ii) temporarily increases with the increasing release of liquid from the fruit (component (a)) and the increased release of, for example, the sugar from component (b) into component (a). Thus, during storage of the food product in a commercial cup of fruit yoghurt, the fresh fruit remains firmly positioned at the bottom of the cup. By means of release of liquid from the fruit (component (a)) the viscosity of the aqueous preparation is increased and gets stiffer, respectively more viscous, which prevents, due to the increased frictional forces that the fruit or fruit pieces are floating toward the top through the milk or soy product. The aqueous preparation thus “glues” the fresh fruit together and immobilizes it, in particular, during production of a food product according to the present invention when component (c) is added. Immobilization of the fruit also results in almost complete avoidance of any discoloration or at least retardation of any discoloration of the component (c), the milk or soy layer by the fruit. Moreover at a storage temperature in the range of 3° C. to 10° C., preferably 6° C. to 8° C., the first layer turns into a creamy-light gelled highly attractive consistency, which is especially preferred by consumers.

The aqueous preparation (b) according to the present invention is thus responsible for preventing the fresh fruit (component (a)) to completely penetrate component (c). The consistency of the aqueous preparation (component (b) is softer than the consistency of the fresh fruit (component (a)), so that the consumer experiences the fruit in a lightly gelled medium during consumption.

Of course, the food product according to the present invention can be made with more layers than just layers one and two. In some cases, it is desirable to have a third layer and/or further layers, whereby the further layers can correspond to the arrangement of the first and second layer. Repeated layering may also be desired.

If pectin is used as a thickening agent in a multilayer food product according to the present invention in addition to one or more galactomannanes, it is possible that the pectin reacts with the bivalent cations calcium and magnesium, which diffuse from the milk or soy product into the aqueous preparation thereby forming a type of network and thus causing a slight contraction of the aqueous preparation. Preferred are milk products over soy products, due to the milk products having a higher portion of bivalent calcium and magnesium cations. The afore-described contraction is compensated by an increase in liquid in conjunction with galactomannane (especially guar gum) and the corresponding swelling and expansion such that as a result in balancing these effects, the consistency of the food product becomes slightly gel-like and creamy. When consuming the food product according to the present invention, there is a slightly elevated temperature in the mouth of the person which leads to a reduction in viscosity and is noticeable to the consumer as a pleasant “melting in the mouth” type sensation.

A further and related aspect of the present invention, refers to the utilization of an aqueous free flowing preparation as afore-describes component (b), as a binder agent for binding fresh, whole fruit and/or fruit pieces, in particular in a multilayered food product, wherein multilayer means at least two layers. Preferred embodiments are according to the foregoing description.

The afore-described food product according to the present invention has been so far described in condition right after production. However, it should be noted that the food product according to the present invention also refers to a food product which has been stored after production. Storage of such a food product leads in some cases to processes within the product which counteract the attractiveness and the appetizing nature of the food product.

Accordingly, present invention respectively refers also to a food product that has been stored after it was freshly produced. Storage is preferably at a temperature in the range from 3 to 10° C., preferably, 6° C. to 8° C.

The present invention refers also to a process for producing a fresh food product, as afore-described. The process according to the present invention comprises the following steps:
providing one or more layers of fresh, whole fruit and/or fresh fruit pieces, as defined as component (a) of the food product according the present invention;
applying an aqueous, flowable preparation, as defined as component (b) of the food product, to the layer, respectively layers of fresh fruit and/or fruit pieces, so that the interstices between the fresh, whole fruit or fruit pieces are filled and forming a first layer of components (a) and (b).

Alternatively, the aqueous preparation can be placed first or simultaneously with the fresh fruit into a container.

If a multilayer food product is to be produced, preferably one layer of milk and/or soy product as component (c) of the food product is arranged over and/or under (preferred is over) the first layer formed by components (a) and (b).

When producing a preferred food product according to the present invention, the aqueous preparation to be utilized is applied to a layer of fresh fruit, such that the level of fluid of the aqueous preparation at production time is below the filling height H_{F} of the fruit. Thus, the aqueous preparation does not completely cover the fruits; however it fills substantially all the interstices between the fruit. Fresh fruit and the aqueous preparation thus from together a first layer, whereby some of the fruit projects from the surface of the first layer. A milk or soy product is then applied to the first layer and overlaps with the first layer and partially surrounding the fruit projecting from the layer. The aqueous preparation then binds the liquid emerging from the fruit over time as well as the liquid that has diffused from the milk or soy product into the first layer, thereby increasing the volume of the aqueous preparation causing the liquid level H_{S} of the aqueous preparation to rise. Simultaneously the level H_{F} of the fruit decreases somewhat due to the loss of liquid.

The food products according to the present invention comprise normally in component (b), that is, the aqueous preparation, in addition to the components (i) and (ii) and in some cases (iii) and/or (iv) and/or (v), also other components. Further preferred components are aroma agents, dyes, and stabilizers and/or fruit components. Fruit components may be fruit extracts, fruit purees, fruit juice, fruit juice concentrates and/or shredded fruit. These components also serve to vary the flavor and can counter any discoloration of the fresh fruit that might occur.

A food product according to the present invention comprising the components (a), (b) and (c) whereby the component (c) is a milk product has the following composition:
15% by weight to 20% by weight fresh, whole fruit and/or fresh fruit pieces (component (a)),
5% by weight to 15% by weight of aqueous preparation (component (b)), preferably 8% by weight to 12% by weight, especially preferred 10% by weight,
70% by weight to 75% by weight milk product (component (c).

A preferred industrial process for producing the food product of the present invention is preferably carried out utilizing liquid tight containers, which each contain one serving of the food product. The layer of fresh, whole fruit and/or fruit pieces (component (a)) is thus placed directly into the serving container. The flowable aqueous preparation (component (b)) is then directly applied to the fruit in order to fill out the interstices either completely or partially between the fruit. Component (c), that is, the milk or soy product (preferably a milk product), if desired can then be placed on this first layer resulting from components (a) and (b). Subsequently, the resulting food product is stored at a temperature above the freezing point, preferably below 10° C., so that during storage, the fresh fruit releases liquid to the aqueous preparation. The fruit liquid increases the water activity in the aqueous preparation and liquid is then absorbed by the galactomannanes (especially guar seed powder) resulting in an increase in the viscosity of the aqueous preparation. This effect is further amplified by use of sugar as component (i) of the aqueous preparation. Since the sugar content in the aqueous preparation decreases due to the transfer of sugar into the fresh fruit, it causes an increase in water activity in the aqueous preparation and the liquid binding capacity of the galactomannanes correspondingly also increases.

It is understood that in the afore-described industrial process, the aqueous preparation can also be placed first in the serving container with the fresh fruit following in a second step.

Advantageously, at the time of production, the fresh fruits are provided in frozen form. In that condition, they are less prone to be squashed due to pressure. In addition, the use of frozen fruit has hygienic advantages, since they do not lose their liquid during handling.

When using frozen fruit or fruit pieces, the resulting food product, is getting already preserved during production. Freezing the fruit markedly reduces germs on the fruit. However, one of the drawbacks may be that ice crystals can form on the fruit, which can actually penetrate the cell walls and vacuoles of the fruit. Thus, if the tissue of the fruit gets destroyed, the fruit juice emerges from the fruit after thawing. For that reason it is especially advantageous, to preserve the fruit for storage by means of a selected course of a temperature-time-curve. Advantageously, the fruit is cooled to a temperature of at least −20° C., whereby the fruit quickly freezes, at which temperature they are then stored. A fast freezing action counteracts the formation of large ice crystals. The formation of ice crystals is also counteracted by advantageously avoiding temperature fluctuations, so that the fruit can benefit from a gentle treatment which also renders it optically more attractive.

Of course, the containers in the industrial production after filling them with the food product (component (a), (b) and also (c)) are subsequently covered with closure means (e.g. a commercially available cover) in order to then store the product.

Other features and advantages of the present invention will be more readily apparent upon reading the following patent claims and the following exemplified embodiment.

### EMBODIMENT

The invention will be illustrated according to the following embodiment and in reference to the accompanying drawing.

The sole FIGURE shows the cross sectional view of a 400 ml container 1 filled with fresh fruit 3 (strawberries) and a milk product 2. The container 1 has a height of H_{B} of 105 mm and a bottom with a diameter of 90 mm and at the head has a diameter of 110 mm. The container 1 is from translucent plastic, so that the food product 0 is easily seen. The content of the container is sealed by means of a plastic foil, which is removed after initial opening. Arranged above the seal is a cover 5. The container can be further provided with a handle (not shown) in such a manner that the container optically appears as “little pail”.

80 g of fruit 3, frozen strawberries, having an average diameter of 20 mm which have been destemmed, are arranged at the bottom of container 1. In the lower area of the strawberries 40 g of an aqueous preparation 4 fill the interstices between the fruit 3 and in the upper area of the strawberries, respectively above the strawberries; 280 g of yoghurt (milk product 2) are arranged.

This represents the composition of a food product 0 of 20% fruit, 10% aqueous preparation and 4% to 70% milk product.

The freezing method of the destemmed strawberries is carried out at minus 20° C. to minus 40° C., the subsequent transport and storage takes place at minus 20° C. After the strawberries are unpacked and dosed into container 1, the temperatures of the strawberries is minus 15° C. to minus 20° C. and have a total germ count of maximally 1000 germs per gram, preferably 500 germs per gram.

The aqueous preparation 4 for pouring over the strawberries has the following composition in which all percentages are weight percent relative to the total amount of the aqueous preparation.
about 50.0% sugar
about 41.25% water
about 0.95% glucose-fructose-syrup
pectin E440 (0.5%)
guar seed powder E412 (0.4%)
xanthan E415 (0.05%)
about 0.20% sodium citrate E331 as an acid regulator.

The milk product 2 consists of sweetened yoghurt (8% by weight crystal sugar, 3.8% by weight fat relative to the total amount of yoghurt). The end product, here the food product 0, has a sugar content of about 11.0% by weight relative to the total amount of food product.

The so produced food product 0 has a minimum shelf life of about 10 days when stored at +6C. Already after 24 hours storage, the product has reached its optimum consistency, since at that time, the fruit juice of the defrosted fruit is by then completely bound to a soft gel through the aqueous preparation 4. At that time the product has also optically a very pleasing quality. The liquid level of the aqueous preparation H_{S} is increased and the level of the fruit layer H_{F} is slightly decreased, so that the fruit 3 is now entirely surrounded by the aqueous preparation 4. The aqueous preparation 4 immobilizes the fruits 3 among themselves as also relative to the bottom of the container 1 and prevent that the fruit 3 can float into the yoghurt. The fruit bed is well visible through the container 1.

When consuming the food product 0, the creamy melting consistency is experienced as very favorable and produces a taste sensation as compared to the conventional products. This condition can be retained for at least 10 days when stored at +6°C.

Reference Numeral List:
0 food product
1 cup
2 milk product
3 fresh fruit
4 aqueous preparation
5 cover
H_{B} height of the cup
H_{S} liquid level of the aqueous preparation
H_{F} height of the fruit layer

1-16. (canceled)

17. A food product comprising the components:
(a) at least one of, fresh whole fruit and fresh fruit pieces; and
(b) an aqueous preparation, which completely or partially fills interstices between the fresh whole fruit or the fruit pieces placed in a container comprising:
(i) one or more of a compound selected from the group consisting of sugars, sugar alcohols, sweeteners, fructo oligosaccharides, polydextrose and other roughage and mixtures thereof in a total amount of more than 25% by weight relative to the total amount of aqueous preparation;
(ii) one or more galactomanannes as a thickening agent for binding liquid from the fruit or fruit pieces during a shelf life of the food product.

18. The food product of claim 17, wherein the total amount of the dissolved solids relative to the total weight of the aqueous preparation is more than 40% by weight.

19. The food product of claim 18, wherein the total amount of the dissolved solids relative to the total weight of the aqueous preparation is more than 45% by weight.

20. The food product according to claim 17, wherein the selected compound are at least one of, sugars and sugar alcohols and mixtures thereof.

21. The foods product according to claim 17, wherein the galactomannane is guar gum powder.

22. The food product according to claim 17, wherein one or more of the galactomanannes are present in an amount in the range from 0.2% to 0.8% by weight relative to the total amount of aqueous preparation.

23. The food product according to claim 21, wherein the guar gum is present in an amount in the range of 0.2% to 0.8% by weight relative to the total weight of the aqueous preparation.

24. The food product according to claim 17, further comprising:
(iii) a low esterized pectin.

25. The food product according to claim 24, wherein the pectin is amidified.

26. The food product according to claim 17, wherein the aqueous preparation further comprises amidified pectin in an amount of 0.5% to 1.0% by weight relative to the total amount of aqueous preparation.

27. The food product according to claim 26, wherein the amount of pectin is 0.5% to 0.75% by weight relative to the total amount of the aqueous preparation.

28. The food product according to claim 17, wherein the aqueous preparation further comprises:
(iv) one or more acid regulators and wherein the aqueous preparation has a pH value in the range of 4 to 5.

29. The food product according to claim 17, wherein the fresh fruit or fresh fruit pieces are present in frozen condition.

30. The food product according to claim 17, wherein the aqueous preparation further comprises:
(v) a food preservative.

31. The food product according to claim 30, wherein the food preservative is one or more members selected from the group consisting of benzoic acid, sorbic acid, their salts and mixture thereof.

32. The food product according to claim 17, wherein
(a) the fruit or fruit pieces are present in frozen condition, and (b) wherein the aqueous preparation filling the interstices between the fruit or fruit pieces has a pH value from 4 to 5, and wherein
(i) one or more of the compounds selected from the group consisting of sugars, sugar alcohols, sweeteners and fructooligosaccharides, polydextrose and roughage and mixture thereof are present in a total amount of from 40% to 45% by weight relative to the total amount of aqueous preparation; and wherein
(ii) one or more of the galactomanannes which are present in an amount in the range from 0.2% to 0.8% by weight relative to the total amount of the aqueous preparation is guar gum powder; and wherein
(iii) the aqueous preparation further comprises amidified pectin in an amount of 0.5% to 1.0% by weight relative to the total amount of aqueous preparation; and wherein
(iv) one or more acid regulators, and
(v) a food preservative selected from the group consisting of benzoic acid, sorbic acid, their salts and mixtures.

33. The food product according to claim 17, further comprising:
(c) at least one of, a milk product and a soy product; and
wherein the food product is multilayered and wherein components (a) and (b) together form a first layer and component (c) forms the second layer and wherein the first and second layers border each other or they overlap.

34. The food product according to claim 17, wherein the first layer is located under the second layer and the filling height H_{F} of component (a) in the first layer is higher than the filling height H_{S} of component (b) in the first layer.

35. A method for producing a food product according to claim 17, comprising the following steps:
providing one or more layers of fresh, whole fruit or fresh fruit pieces in a container,
adding the aqueous preparation to the layers of fresh, whole fruit or fresh fruit pieces such that the interstices between the fresh whole fruit or fresh fruit pieces are completely or partially filled thereby from component (a) and (b) a first layer,
adding a layer from a milk or soy product a component (c) either above or below the first layer.

36. The method according to claim 35, wherein the milk or soy layer is added on top of the first layer.

37. The method of claim 35 of preparing the food product, further comprising storing the product at a temperature in the range of from 3° C. to 10° C.

38. The method of claim 37, wherein the temperature is in the range of from 6° C. to 8° C.

39. A method of using the component (b) of claim 17, as a binder in the production of a multilayered food product, comprising adding component (b) in its aqueous form to the fresh, whole fruit or fresh fruit pieces and storing the food product in a cool atmosphere until consumption.
